(19) United States
(12) Patent Application Publication
(10) Pub. No.: US 2026/0336250 A1
(43) Pub. Date: Oct. 29, 2026

(54) CORRUGATED CARDBOARD PRODUCTION UNIT AND METHOD FOR MONITORING A CORRUGATED CARDBOARD PRODUCTION UNIT

(71) Applicant: BHS Corrugated Maschinen- und Anlagenbau GmbH, Weiherhammer (DE)

(72) Inventor: Stefan Trenz, Neuhaus (DE)

(21) Appl. No.: 19/101,664

(22) PCT Filed: Aug. 3, 2023
(86) PCT No.: PCT/EP2023/071491

§ 371 Date: Feb. 6, 2025

(30) Foreign Application Priority Data
Aug. 11, 2022 (DE) 10 2022 208 364.4

(51) Int. Cl. B31F 1/28; G06T 7/73

(52) U.S. Cl. CPC B31F 1/284; G06T 7/74; G06T 2207/30204

(57) ABSTRACT

The invention relates to a corrugated cardboard production unit (2) and to a method for monitoring such a corrugated cardboard production unit (2), wherein a defined region of a conveyor device (4) of the corrugated cardboard production unit (2) is specified as a test region (12), a camera system (20) comprising at least one camera (22) is provided, by means of which images (I1) are captured, wherein the camera (22) is oriented in the direction of the test region (12) such that the test region (12) is imaged in the captured image (I1), and wherein the position of the markers (14) is detected using the camera system (20) and the test region (12) is determined in the captured image (I1) on the basis of the detected position. If a deviation of the imaged test region (12) from a target orientation (27) is identified, an automatic image correction is preferably carried out. In this manner, an inspection of the adjustment of the camera (22) is facilitated and a reliable image analysis is ensured for a subsequent analysis, for example in order to automatically inspect the flatness of the sheets (6).

### DESCRIPTION

The invention relates to a corrugated cardboard production unit and a method for monitoring a corrugated cardboard production unit.

Corrugated cardboard production units are well known and are used for producing individual sheets made of corrugated cardboard. During the production of the sheets, the aim is to achieve the best possible flatness of the individual sheets, since this is a decisive criterion in terms of quality and further processing. Flatness is understood here to mean that a particular sheet is designed to be flat and without any bend. A deviation from such a flatness in the form of a curvature is also referred to as a “warp”.

From EP 1 473 147 A1 , it is known that undesired curvature of the sheets can be detected using a camera-based system. The height levels of various points on a sheet are detected and analyzed. The inspection of sheets with regard to deviations from flatness is also referred to below as “warp detection”.

Camera-based systems for monitoring a corrugated cardboard production unit and checking the corrugated board produced are also generally known. Markers are applied to the corrugated cardboard. For example, DE 102015 204 407 A1 describes a luminescent marker system.

The detection of a deviation from the flatness requires a high degree of accuracy in order to obtain reliable information about such a deviation in such a camera-based monitoring system.

Based on this, the invention is based on the object of ensuring reliable monitoring of a corrugated cardboard production unit, in particular a reliable monitoring of the sheets produced, specifically with regard to a deviation from flatness.

According to the invention, the object is achieved by a corrugated cardboard production unit with which
at least one conveyor device extending in a longitudinal direction and provided with at least one conveyor belt is provided for conveying sheets made of corrugated cardboard,
a defined region of the conveyor device, specifically the conveyor belt, is specified as a test region (region of interest),
a plurality of markers, which are correlated to the test region, are attached in a fixed position to the conveyor device,
a camera system comprising at least one camera is provided, wherein preferably exactly one camera is provided per conveyor belt, which camera is designed for capturing images and is oriented in the direction of the test region and also configured such that the test region is imaged in the image captured in each case,
wherein the camera system is also designed for optically detecting the position of the markers,
an analysis unit is provided, which is configured to determine the test region in the shown image on the basis of the detected position of the markers.

According to the invention, the object is further achieved by a method for monitoring a corrugated cardboard production unit with which
a defined region of a conveyor device of the corrugated cardboard production unit is specified as a test region,
a camera system comprising at least one camera is provided, by means of which images are captured and which is oriented in the direction of the test region, such that the test region is imaged in the captured image,
wherein the position of the markers is detected using the camera system and the test region in the captured image is determined on the basis of the detected position.

The advantages and preferred design variants listed below for the corrugated cardboard production unit can also be applied analogously to the method and vice versa.

The embodiments according to the invention are based on the consideration that a highly precise adjustment of the particular camera in relation to the test region, i.e. to the “region of interest” (ROI), is required for the reliable and precise analysis of the images captured with the camera system, in particular with regard to monitoring flatness. Furthermore, the invention is based on the realization that during operation of the unit, even after an initially highly accurate adjustment of the camera system, a misalignment can occur, so that, for example, the captured image exhibits errors, such as distortion or rotation, compared to a correct adjustment of the camera. Such a misalignment and the resulting image artifacts are disadvantageous for downstream image analysis, specifically with regard to identifying the flatness of the respective sheets.

By determining the position of the markers in the shown image, the actual image and orientation of the test region in the captured image (imaged test region) is therefore detected. This test region imaged in the image is taken into account for further image analysis, in particular for warp detection.

With the method described here, automatic image analysis is used in particular to determine and identify the actual test region in the captured image on the basis of the identified positions of the markers and preferably to inspect whether this is correctly represented in the image.

The test region preferably has a width that corresponds to the width of the conveyor belt. Furthermore, the test region has a depth in the longitudinal direction that is preferably less than 1 m and in particular in a range between 40 cm and 75 cm. Depending on the arrangement of the camera, the depth can also be greater.

The analysis unit has a suitable computing unit with processor memory etc. for testing and analysis. Algorithms or computer programs are stored for the analysis, based on which the corresponding analysis and tests are carried out fully automatically using the captured image data and, if applicable, other sensor data. Known or adjusted image analysis algorithms can be used for this purpose

Due to the system according to the invention, a correct orientation of the at least one camera with respect to the test region is therefore particularly inspected based on the detected position of the markers attached in a fixed position. If an incorrect orientation (misalignment) is recognized, suitable measures are preferably taken to at least compensate for such a misalignment. This is carried out in particular by automatically correcting the captured image. The corrected image is then used for subsequent further automatic (image) processing, in particular for warp detection.

This inspection is carried out continuously during operation of the corrugated cardboard production unit. That is, the camera system continuously captures images, which are continuously subjected to image analysis. In particular, it is provided that an image analysis, in particular a warp detection, is carried out for each individual sheet and that the inspection described here of the correct orientation is carried out in advance.

According to a first embodiment, the camera is used to capture individual images and, in a second embodiment, image sequences are created and further processed in the form of a stream.

It should be emphasized that the markers are located in a fixed position on the conveyor device, for example on the edge side of the conveyor belt. Therefore, they are not markers attached to the corrugated cardboard. For example, the markers define the corner points of the test region.

In particular, the conveyor device is a section of the corrugated cardboard production unit in the region of the so-called “dry end”. In particular, the conveyor device is part of a stacking system that is provided downstream of a cross-cutter, which divides the continuous corrugated board produced into individual sheets. The sheets are stacked in the stacking system on one or more conveyor belts, also known as stacking belts, and conveyed further, for example to a stacking apparatus. The individual sheets are stacked and conveyed in an overlapping arrangement. Therefore, they are placed on top of one another in a shingle-like manner. This is also referred to below as a “shingled arrangement”.

A plurality of conveyor belts are often provided, which are provided next to one another and, in particular, one above the other. In such a case, one such camera system is installed at each conveyor belt in each case. The at least one camera is oriented with a special partial region of the conveyor device and in particular the conveyor belt, which forms the test region of the conveyor device. This means that the camera images a partial region of the conveyor device in a particular captured image. The camera is adjusted such that at least part of the captured image images the test region.

If it is mentioned here that the camera system is designed for detecting the position of the markers, this is understood to mean optical detection of the position of the individual markers. This is preferably carried out with the camera that also images the test region.

Alternatively or in addition to this, it is also possible to provide separate additional optical sensors, for example additional cameras, wherein its position is firmly correlated to the position of the at least one camera that images the test region, so that a correlation can be established between the position of the markers detected by these additional optical sensors and the image captured by the camera.

Preferably, a specified target orientation is specified for the imaged test region, wherein the analysis unit is configured to inspect the captured images based on the detected position of the markers to determine whether the target orientation corresponds to the orientation of the imaged test region.

In particular, this inspects whether one or more edges of the test region are imaged in the desired orientation in the image. Thus, the markers are generally provided in pairs opposite one another along a connecting line transverse to the longitudinal direction. Therefore, the connecting line defines a specified orientation of the test region, which-when correctly adjusted-is horizontally oriented in the captured image.

If a deviation from the target orientation is identified, in a preferred embodiment the captured image is subjected to an image transformation using the analysis device, such that the imaged test region assumes the specified target orientation. For this purpose, the image is subjected to a suitable image transformation. If, for example, it is recognized that the imaged test region is rotated or distorted in relation to the target orientation, a rotation and/or rectification of the image is carried, out, so that the imaged test region is brought into line with the target orientation. Therefore, this measure makes the image processed in this way available for subsequent further image analysis, in particular with regard to the analysis of flatness (warp detection).

In a preferred embodiment, a capture region of the at least one camera is selected such that both the test region and the markers are simultaneously contained in a particular captured image. In this manner, a particularly simple analysis and inspection are possible, since the position of the markers is already directly contained in the captured image. Using automatic image analysis, the position of the markers in the image is recognized and the actual test region imaged in the image is thus determined. This is then compared in particular with the specified target orientation.

The optical markers have generally defined optical properties. Such optical properties are, for example, the color, a light intensity, a defined geometry of the markers or, when using active light pulses as markers, a specified pulse frequency. Furthermore, a filter is provided, which is sensitive with regard to the particular optical property. The filter can be an optical filter for the camera. This is moved in front of the camera temporarily and thus alternately, for example, or alternatively is permanently attached.

Preferably, the filter is an electronic filter that is integrated in the analysis unit, specifically within the automatic image analysis. The term “sensitive to the particular optical property” means that the filter is designed with regard to the optical property and, for example, has a certain bandwidth, so that (only or mainly) the particular optical property (e.g., color) is transmitted. With an electronic filter, the particular property is preferably emphasized and other image information that does not correspond to the optical property is at least partially suppressed.

Due to this measure, the individual markers are unambiguously identifiable and, in particular, easily distinguishable from the other image contents, so that the automatic image analysis gains in reliability. Overall, due to such filtering, an unambiguous assignment of the markers in terms of their position is therefore ensured, and thus a reliable identification of the test region in the captured image.

In an expedient further development, the various markers differ in terms of their optical properties, such as those mentioned above, and the analysis unit is also designed to identify these different optical properties, in particular using automatic image analysis. In this manner, it is ensured that the position of the markers is precisely detected and that, for example, the positions of two markers are not accidentally swapped or incorrectly assigned.

According to a preferred first design variant, the markers are reflective elements, also known as reflectors, or luminescent elements. Specifically, these are, for example, adhesive films that are designed in particular as reflective films or are luminescent. Reflective elements are generally understood to mean that they have a reflectance greater than 0.8 or 0.9. Reflectance is understood to mean the ratio between incident and reflected light.

In a preferred further development, active illumination of the markers is provided in the design variant with the reflective elements, so that they appear as illuminated image elements in the captured image due to their high reflectance and can thus be unambiguously identified.

Whenever “reflective films” are mentioned herein, this refers in particular to so-called “retroreflective foils” in which the incoming light is reflected back in the direction of the illuminating light source and thus in particular to the camera, at least largely independently of the angle of incidence.

Such reflective elements or luminescent elements are also referred to as passive markers, since they do not have their own light source. The advantage of these special passive markers compared to other passive markers, such as a simple color marker, is their improved visibility, so that the risk of analysis errors during automatic image analysis is reduced.

In a preferred further development, the markers are active markers comprising at least one (active) light-emitting element. Therefore, they are also referred to as light-active markers. The light-emitting element forms an active, in particular controllable light source and is designed, for example, as an LED or a plurality of LEDs. With the use of active markers, their visibility and identification in the captured image is increased, so that image analysis is reliable.

In an expedient embodiment, the light-emitting elements are designed for outputting light pulses, i.e. a pulsating light signal is emitted by the active marker. A constant, specified pulse frequency is preferably set.

In the design variant with the different optical properties of the various markers, different markers have different pulse frequencies in a preferred further development.

Specifically when using variable markers, such as light pulses, a video or stream is captured and analyzed with the camera, so that the changes over time, specifically the pulsing/flashing and in particular the pulse frequency(s), are detected and analyzed.

When using active markers, in a preferred embodiment, the light-emitting element is oriented in the direction of the camera. In this manner, a detection of the position of the marker is reliably ensured.

In a preferred embodiment, with the active marker, an adjusting element is provided for orienting the light-emitting element and/or an aperture. This is used in particular for orienting the light-emitting element in the direction of the camera or, when orienting an aperture, for orienting the light emitted by the light-emitting element.

In a preferred embodiment, the active marker has a diffuser or an optical filter, which is provided in front of the light-emitting element. Studies have shown that, in certain situations, overexposures can occur in the captured image due to the active light-emitting element, which are detrimental to further image analysis. Therefore, due to the diffuser, the light intensity that occurs is reduced. As an alternative to the diffuser, a suitable filter can be used, for example for reducing the light intensity.

The markers are preferably placed on the edge side next to the conveyor belt of the conveyor apparatus and mark the corner points of the test region in particular. Alternatively, they have a fixed location relationship to the corner points of the edge region.

The test region is preferably a rectangular region. Preferably, at least four markers are provided, i.e. two on each edge side. Each marker is preferably assigned to a corner point of the test region.

The camera is preferably provided at a distance from the test region opposite a conveyor device and thus opposite the longitudinal direction of the conveyor system. The camera is positioned in a range between 1 m and 4 m from the test region, for example. Furthermore, the camera is preferably provided above the conveyor belt, so that it is directed at an oblique angle towards the test region.

In a preferred embodiment, the at least one camera is provided centrally with respect to the conveyor belt, i.e. at half the width of the conveyor belt.

In a preferred further development, the analysis unit is also configured to make statements about a property of the sheets, in particular about the flatness of the sheets, on the basis of the captured images. Methods of automatic image recognition are used for this purpose. Preferably, the course of an edge of the sheet is analyzed with regard to curvature. The edge of the sheet is positioned in the specified image region and thus in the test region.

According to the invention, a corrugated cardboard production unit is also designed with the features of claim 15. This combination of features represents an independent invention. The submission of a divisional application for this remains reserved. The aspects described below in connection with this further invention also represent preferred further developments of the previously described corrugated cardboard production unit and the previously described method.

According to this aspect, an enclosure is attached in the region of the test region, which at least partially covers the conveyor device, at least the conveyor belt, and spans it in the transverse direction at right angles to the longitudinal direction. Using this enclosure, a targeted shading of the test region from the surroundings is carried out, so that the test region is at least partially protected and shaded from incident light, specifically from the side or from above. Furthermore, a lighting element is provided to illuminate the test region and specifically the front edge in a defined manner. Due to this measure, the visibility of the test region, and in particular the markers or front edges of the sheets, is improved, so that the automated image analysis is more reliable and accurate.

Due to the improved and dedicated illumination, e.g., markers for identifying the test region can also be dispensed with. However, they are still preferably used as described above. Due to the targeted illumination, the markers are easier to recognize, in particular when using passive markers.

A further advantage of the enclosure is also seen in the fact that, in addition to providing optical shading, it also offers protection for the test region, for example, against contamination.

In a preferred embodiment, the lighting element can be dimmed, so that the light intensity can be set. In this manner, an adjustment of the light intensity to the ambient lighting conditions is facilitated and also undertaken during operation.

Alternatively or additionally, the light color can be set. In this manner, the recognizability of structures in the test region for the camera can be improved on a targeted basis. Specifically when using passive markers, the recognizability of the markers can be improved by selecting the light color.

The lighting element is preferably attached to the enclosure, particularly on the inner side. In a preferred embodiment, the enclosure generally has at least one side wall and preferably two side walls and an upper wall. The upper wall preferably spans the entire width of the conveyor belt. In particular, it connects the two side walls. They are fastened on the edge side of the conveyor device, for example. Overall, the enclosure is L-shaped and preferably U-shaped in a view in the direction of the longitudinal direction. Due to the arrangement on an inner side, and in particular on the inner side of the upper wall, a targeted illumination of the region shaded by the enclosure is achieved.

In a preferred embodiment, the lighting element is attached and/or shaded such that the lighting element is not visible to the camera and/or that the light output by the lighting element does not shine into the camera. The term “not visible” is understood to mean that the lighting element is not recognizable in the image captured by the camera. At the very least, the lighting element, specifically a cone of light output by the lighting element, is oriented such that it does not shine into the camera. In this manner, good recognizability of the illuminated test region is ensured, in particular without any overexposure (excessive brightness) of partial regions in the image captured by the camera. In order to realize this shading of the lighting element in the direction of the camera, for example, an aperture is provided.

With regard to the best possible shading of the test region, the enclosure is made of a visually non-transparent, opaque material.

The enclosure is preferably only formed in the region of the test region, so it only extends over a section of the conveyor device. It is specifically adjusted, for example, to the length of the test region in the longitudinal direction and has a length that corresponds to a range between 0.5 times and twice the length of the test region. Preferably, the length corresponds, for example, to 0.7-1.5 times the length of the test region.

The height of the enclosure is preferably in a range between 0.2 m and, for example, up to a maximum of 1 m and is preferably in a range of less than 0.7 m or even less than 0.5 m-relative to the height of the conveyor belt. Overall, in this manner, a comparatively narrow region of the conveyor device is shaded and thus optimally protected from ambient light.

In a preferred embodiment, the lighting element extends transversely to the longitudinal direction and has a plurality of individually controllable regions. Therefore, the individually controllable regions can be used to illuminate defined transverse regions on a targeted basis. This is particularly useful if the entire width of the conveyor device is not utilized, i.e. if the overlying sheets do not cover the entire width.

The lighting element specifically has a plurality of light-emitting elements. Individual LEDs are preferably used as light-emitting elements. The light-emitting elements can be controlled either individually or in groups in order to form the controllable regions.

The various options described above, for example the dimmability for setting a suitable illumination intensity, the setting of the light color (specifically through the use of RGB light sources), are preferably also implemented during operation of the unit, i.e. during the carrying out of the method, and carried out individually or in any combination.

An exemplary embodiment of the invention is explained in more detail below in connection with the figures. These show, in sometimes highly simplified representations

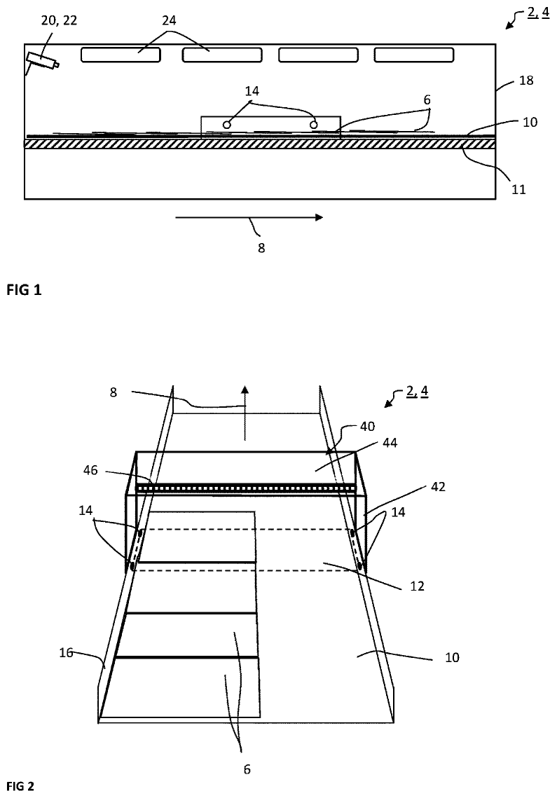

FIG. 1 a conveyor device as part of a corrugated cardboard production unit in a lateral cross-sectional view,

FIG. 2 a perspective view of a conveyor belt in the direction of view of a camera,

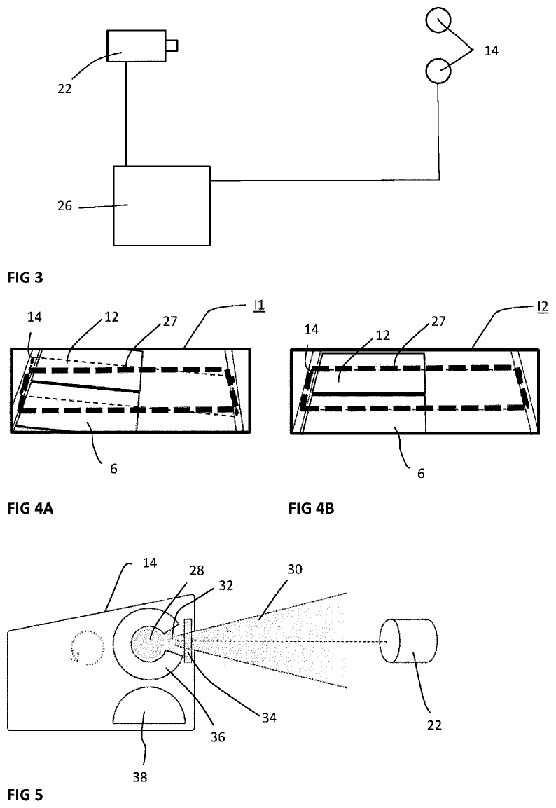

FIG. 3 a schematized block diagram of a camera, an analysis unit and markers,

FIGS. 4A, 4B representations for explaining the correction of a captured image and

FIG. 5 an exemplary, highly simplified representation of a light-active marker with a camera.

FIG. 1 and FIG. 2 show, in highly simplified representations, as a section of a corrugated cardboard production unit 2, a partial region of a conveyor device 4, by means of which individual sheets 6 made of corrugated cardboard are conveyed and transported in a conveying direction. The conveying direction simultaneously defines a longitudinal direction 8 of the conveyor device 4. The conveyor device 4 has a conveyor belt 10, which is guided by a belt carrier 11.

The individual sheets 6 lie on the conveyor belt 10, in each case overlapping a section in the longitudinal direction 8. During operation, the conveyor belt 10 runs continuously, so that the sheets 6 are conveyed continuously in the longitudinal direction 8. The conveyor belt 10 has a width transverse to the longitudinal direction 8, which is typically in a range between 100 cm and 400 cm and in particular in a range between 250 cm and 350 cm. This width defines the maximum corrugated board width that can be produced with the corrugated cardboard production unit 2. In the exemplary embodiment, the width of the sheets 6 is significantly smaller than the width of the conveyor belt 10.

The conveyor device 4 is assigned a specified partial region as a test region 12. This is shown by dashed lines in FIG. 2. This is preferably a rectangular partial region of the conveyor device 4, specifically the conveyor belt 10. In the exemplary embodiment, markers 14 are provided at the corner points of the test region 12, on the edge side of the conveyor belt 10. For example, they are integrated in a flange 16 on the edge side. In principle, they are mounted in a fixed position on the conveyor device 4.

The conveyor device 4 also generally has a support frame 18 (see FIG. 1), via which the conveyor device 4 is fastened to a floor, for example, and which is also designed for mechanically supporting the conveyor belt 10. Only one conveyor belt 10 is shown in the exemplary embodiment. However, conveyor devices 4 often have a plurality of conveyor belts 10, which are provided one above the other or next to one another, for example. Typically, a particular conveyor belt 10 is provided in a manner inclined at an angle and conveys the sheets 6 to a higher level. Following the conveyor belt 10, a stacking apparatus is typically provided for stacking the individual sheets 6.

A camera system 20, which has at least one camera 22 and is formed by this in the exemplary embodiment, is also assigned to a particular conveyor belt 10. The camera 22 is positioned against the longitudinal direction 8 in front of the test region 12 and slightly above the conveyor belt 10. The camera 22 is oriented in the direction of the test region 12, i.e. a detection region of the camera 22 is oriented towards the test region 12.

Typically, the conveyor device 4 has a lighting apparatus 24 comprising at least one lighting element, using which at least a partial region and in particular the test region 12 is suitably illuminated. A plurality of lighting elements are shown in the exemplary embodiment in FIG. 1. Due to the illumination of the test region 12, it is ensured that the images I1 captured by the camera 22 (see, for example, FIG. 4A) are of sufficient quality for the intended image analysis. Depending on the design of the markers 14, specifically if they are designed as reflective elements or as luminescent elements, the lighting also ensures that the markers 14 are easily recognizable in the captured image I1. Specifically, in a preferred embodiment, a lighting element is positioned in the region of the camera 22 and illuminates the markers 14 from there.

A corrugated cardboard production unit 2 generally consists of a plurality of components. Using the corrugated cardboard production unit 2, a continuous corrugated board is initially produced from paper webs, which is then cut for producing the individual sheets 6. The structure and mode of operation of such a corrugated cardboard production unit 2 is known in principle and typically as follows:

The paper webs are unwound from a dispenser and fed to the further downstream components of the corrugated cardboard production unit 2. So-called “splicers”, for example, are provided for uninterrupted operation, with the aid of which, uninterrupted operation is facilitated even when changing paper rolls.

Using a so-called “single-sided machine” (single facer), a single-sided corrugated board web is initially produced. Here, one of the paper webs is grooved using a corrugated roller and then glued to a first cover web on one side. This is typically fed to other machines via a so-called “bridge” for further processing, and a second cover web is typically glued onto the grooved layer of the single-sided corrugated board web opposite the first cover web. For this purpose, this is typically initially fed into a so-called “preheater”. A gluing unit is provided for gluing. In order to facilitate quality and trouble-free operation, heating apparatuses, pulling apparatuses and other belt guides are also preferably provided for guiding the paper webs and/or the corrugated board web produced. The partial region of a corrugated cardboard production unit up to the production of the double-sided corrugated board is designated as the so-called “wet end”.

This is followed by the dry end. With this, a processing and a cutting to size of the previously produced continuous corrugated board web are carried out. Typically, a so-called “short cross cutter” is initially provided, which is used to remove the so-called “start-up waste” during a format change, for example. Furthermore, the dry end has an automatic cutting and creasing machine, particularly downstream of the short cross cutter, which cuts or at least creases the corrugated board web in the longitudinal direction and thus inserts defined click regions.

Finally, a so-called “cross cutter” is provided downstream, which cuts through the corrugated board web in the transverse direction for producing the individual sheets 6. The stacking system, which has the conveyor device 4 described above, is also provided downstream of the cross cutter. The stacking apparatus for stacking the individual sheets 6 is typically provided downstream of the conveyor device 4.

The special embodiment of the corrugated cardboard production unit 2 and the method for determining the test region 12 in images I1 captured by the camera 22 are explained in more detail below, in particular in connection with FIG. 3, FIG. 4A and FIG. 4B:

According to FIG. 3, the camera 22 is connected to an analysis unit 26. In the exemplary embodiment, it is also shown that the analysis unit 26 is connected to the markers 14, for example in order to control them. This is provided in particular in the case of so-called “active markers” 14, which have an active light-emitting element 28 (see FIG. 5).

During operation of the corrugated cardboard production unit 2, the camera 22 continuously captures images and transmits the captured images I1, i.e. the corresponding electronic image data, to the analysis unit 26. The analysis unit 26 is suitably configured to carry out automatic image analysis and image processing. For this purpose, the analysis unit 26 has at least one suitable processor and one or more suitable algorithms and a memory.

The analysis unit 26 carries out the following steps in particular, which are also explained in more detail in connection with FIG. 4A and FIG. 4B:

Initially, the markers 14 shown in the captured image I1 are identified in the captured image I1 using automatic image recognition and the test region 12 shown in the captured image I1 is thus also determined.

In the next step, it is automatically inspected whether the shown test region 12 has a specified target orientation 27. This is shown in FIG. 4A and FIG. 4B by a thick dashed line and as a rectangle. Typically, when correctly adjusted, the camera 22 is oriented such that a horizontal line in the image I1 shown runs parallel to a connecting line between two opposing markers 14. A deviation of the connecting line from the horizontal indicates a rotation of the camera 22. The connecting line is automatically determined during image analysis on the basis of the ascertained positions of two opposing markers 14.

In addition or alternatively, it is also inspected whether the angular position of the individual markers 14 relative to one another corresponds to an expected target angle. Based on the arrangement of the camera 22 above the conveyor belt 10 and in front of the test region 12, a vanishing point perspective is created, which causes the test region 12, which is rectangular in shape, to appear trapezoidal in the shown image I1. A deviation from the expected target angles, for example, indicates a distortion.

If a deviation of the test region 12 shown in the captured image I1 from the target orientation 27 is identified during this inspection, an image correction is preferably undertaken automatically, in which an image transformation is carried out, so that the test region 12 shown in the image assumes its specified target orientation.

FIG. 4A shows by way of example a deviation from the target orientation 27 due to a rotation. During the image transformation, the shown test region 12 is rotated and brought into the desired target orientation. The result of this image processing is a corrected image I2, which is preferably output and/or saved. The corrected image I2 is shown by way of example in FIG. 4B.

The result of this image processing, specifically the corrected image I2, forms the basic template for further automatic image analysis, in particular for inspecting the flatness of the individual sheets 6. Based on the previous inspection and, if applicable, correction of the orientation of the test region 12 shown in the image, a reliable automatic, camera-based inspection of the flatness of the individual sheets 6 is facilitated.

FIG. 5 shows by way of example an embodiment of a marker 14 as an active marker 14. This has the aforementioned light-emitting element 28, specifically an LED, which emits light in the direction of the camera 22. Preferably, the active marker 14 is configured and/or positioned such that the emitted light is oriented in the direction of the camera 22. The emitted light is represented in FIG. 5 by a light beam 30.

In the exemplary embodiment, the active marker 14 has a lens 32 connected upstream of the light-emitting element 28 and a diffuser 34. These elements are used to set the desired focusing or widening of the emitted light on a targeted basis.

FIG. 5 also shows an aperture 36, which in the exemplary embodiment is designed as a circular ring segment, which surrounds the light-emitting element 28 and has a defined opening region.

Furthermore, in a preferred embodiment, an adjusting element 38, which is only shown in greatly simplified form, is provided, with the aid of which the aperture 36 can be set and, in particular, rotated. In this manner, the orientation and/or widening of the light beam 30 is defined.

In a preferred embodiment, the light-emitting element 28 emits light pulses with a defined frequency. Therefore, a particular active marker 14 flashes with a specified flashing frequency.

Preferably, different frequencies are set and provided for the different markers 14, so that a differentiation of the markers based on the flashing frequencies is facilitated.

The analysis unit 26 is configured to detect and analyze these flashing frequencies. In particular, a plurality of captured images I1 are compared with one another for this purpose. Furthermore, the image capture frequency of the camera 22 is sufficiently high to be able to identify and, in particular, analyze the sequence of light pulses.

A total of 22 images are captured by the camera at a suitable capture rate (frame rate). The capture rate, for example, is in a range of 30 to 60 frames per second (30Hz-60Hz). In principle, cameras with higher or lower capture rates can also be used.

The frequency for the light pulses is preferably matched to the capture rate of the camera and, in particular, coupled to it. For example, it is possible to ascertain the frequency of the light pulses based on the number of images between two light pulses. Therefore, the frequency of the light pulses is generally preferably lower than the capture rate of the camera.

Preferably, the camera 22 is generally a CCD camera having a suitable CCD sensor with a suitable pixel density. A resolution of the camera 22 is sufficiently high. Specifically, the resolution is in the millimeter range, i.e. two adjacent pixels in the captured image I1 represent a real distance (of the test region 12) in a range of a few millimeters, in particular in a range of 1-5 mm.

In connection with FIG. 2, an enclosure 40 is formed in the region of the test region 12 as a preferred further development, but also as an independent invention. In the exemplary embodiment, this enclosure 40 is designed to be U-shaped and has two side walls 42 and an upper wall 44, which connects the two side walls 42 to one another. The enclosure 40 spans the entire width of the conveyor device 4 in the test region 12. In the exemplary embodiment, the enclosure 40 has a length in the longitudinal direction 8 that corresponds to the length of the test region 12. A lighting element 46 is provided on the inner side of the upper wall 44 and extends transversely across the conveyor belt 10. The lighting element 46 has individual light-emitting elements, in particular individual LEDs, which are lined up next to one another in the transverse direction. Therefore, the lighting element 46 is a type of LED bar. The lighting element 46 can be dimmed and is preferably also dimmed as a function of the current lighting situation during operation. Furthermore, in a preferred further development, there is also the option to set the color, which is preferably also suitably selected in operation in order to enhance the recognizability of desired structures within the test region 12 in the image of the camera. In this manner, the visibility of the front edges of the sheets 6 and/or the markers 14 is specifically improved. The lighting element 46 has individually controllable regions or segments, which are preferably provided next to one another in the transverse direction. In particular, in each case these regions are groups of individual LEDs.

Due to this embodiment, the test region 12 is suitably illuminated as a function of the current requirements and lighting situation, wherein the intensity and/or the color are set appropriately for this purpose. Due to the enclosure 40 with the defined illumination of the test region 12, the recognizability of the markers 14 or the front edges of the individual sheets 6, based on which WARP recognition is preferably carried out, is improved. Due to the enclosure 40, the test region 12 is protected from stray light and other sources of interference from outside as well as from contamination. A cone of light output by the lighting element 46 is preferably oriented obliquely in a downward direction, and preferably overall such that a shadow cast by the front edge 26 stands out as much as possible.

### LIST OF REFERENCE SIGNS

2 corrugated cardboard production unit
4 conveyor device
6 sheet
8 longitudinal direction
10 conveyor belt
11 belt carrier
12 test region
14 markers
16 flange
18 support frame
20 camera system
22 camera
24 lighting apparatus
26 analysis unit
27 target orientation
28 light-emitting element
30 light beam
32 lens
34 diffuser
36 aperture
38 adjusting element
40 enclosure
42 side wall
44 upper wall
46 lighting element
I1 captured image
I2 corrected image

1. A corrugated cardboard production unit comprising:
at least one conveyor device extending in a longitudinal direction for conveying sheets made of corrugated cardboard;
a defined region of the conveyor device specified as a test region;
a plurality of markers attached in a fixed position to the conveyor device and correlated to the test region;
a camera system comprising at least one camera for capturing images wherein the camera is oriented in the direction of the test region such that the test region is imaged in the image captured in each case, wherein the camera system is also designed for detecting the position of the markers; and
an analysis unit configured to determine the test region in the captured image on the basis of the detected position of the markers

2. The corrugated cardboard production unit according to claim 1, wherein a specified target orientation is specified for the imaged test region, wherein the analysis unit is configured to inspect the captured images based on the detected position of the markers to determine whether the target orientation corresponds to the orientation of the imaged test region

3. The corrugated cardboard production unit according to claim 2, wherein the analysis device is designed such that, if the target orientation does not match the orientation of the imaged test region, the captured image is subjected to an image transformation, such that the imaged test region assumes the specified target orientation.

4. The corrugated cardboard production unit according to claim 1, wherein capture region of the at least one camera is selected such that both the test region and the markers are simultaneously contained in a particular captured image.

5. The corrugated cardboard production unit according to claim 1, wherein the markers have defined optical properties and in that a filter is provided, which is sensitive with regard to these optical properties.

6. The corrugated cardboard production unit according to claim 1, wherein the various markers differ in terms of their optical properties and the analysis unit is designed for distinguishing the markers based on different optical properties.

7. The corrugated cardboard production unit according to claim 1, wherein the markers are reflective elements and/or luminescent elements.

8. The corrugated cardboard production unit according to claim 1, wherein the markers are active markers comprising at least one light-emitting element.

9. The corrugated cardboard production unit according to claim 8, wherein the light-emitting elements are designed for outputting light pulses.

10. The corrugated cardboard production unit according to claim 9, wherein the light-emitting elements of different markers differ with regard to frequency.

11. The corrugated cardboard production unit according to claim 8, wherein the active marker has one or more of the following properties,
the light-emitting element is directed in the direction of the camera (22),
an adjusting element is provided for orienting the light-emitting element and/or an aperture,
a diffuser or a filter is assigned to the light-emitting element.

12. The corrugated cardboard production unit according to claim 1, wherein the markers are in each case placed on the edge side next to a conveyor belt of the conveyor device and in particular mark corner points of the test region

13. The corrugated cardboard production unit according to claim 1, wherein the at least one camera is provided above the conveyor belt and at a distance from the test region opposite the longitudinal direction.

14. The corrugated cardboard production unit according to claim 1, wherein the analysis unit is configured to make statements about a flatness of the sheets on the basis of the captured images.

15. The corrugated cardboard production unit according to claim 1, further comprising
an enclosure covering the conveyor device attached in the region of the test region, and
a lighting element which illuminates at least part of the test region.

16. The corrugated cardboard production unit according to claim 15, in which one or more of the following features is/are realized
a) the lighting element can be dimmed and/or the light color can be set,
b) a cone of light emanating from the lighting element is oriented obliquely in the direction of the test region,
c) the lighting element is attached to an inner side of the enclosure,
d) the enclosure has at least one side wall,
e) the lighting element is attached and/or shaded such that the lighting element is not visible to the camera and/or the light output by the lighting element does not shine into the camera,
f) the enclosure is made of an opaque material,
g) the enclosure is formed only in the region of the test region and has a length in the longitudinal direction that is adjusted in particular to the length of the test region,
h) the lighting element extends transversely to the longitudinal direction and has a plurality of individually controllable regions, LEDs, which can be controlled individually or in groups.

17. A method for monitoring a corrugated cardboard production unit, according to claim 1, in which
a defined region of a conveyor device of the corrugated cardboard production unit is specified as a test region,
a camera system comprising at least one camera is provided, by means of which images are captured and which is oriented in the direction of the test region such that the test region is imaged in the captured image,
wherein the position of the markers is detected using the camera system and the test region in the captured image is determined on the basis of the detected position.
